(19) United States
(12) Patent Application Publication
(10) Pub. No.: US 2022/0356293 A1
(43) Pub. Date: Nov. 10, 2022

(54) PHOSPHONIUM-CONTAINING POLYURETHANE COMPOSITIONS

(71) Applicant: Hewlett-Packard Development Company, L.P., Spring, CA (US)

(72) Inventors: Zhang-Lin Zhou, San Diego, CA (US); Xiaoqi ZHOU, San Diego, CA (US); Or BRANDSTEIN, San Diego, CA (US)

(73) Assignee: Hewlett-Packard Development Company, L.P., Spring, TX (US)

(21) Appl. No.: 17/642,306

(22) PCT Filed: Dec. 16, 2019
(86) PCT No.: PCT/US2019/066473

§ 371 Date: Mar. 11, 2022

(51) Int. Cl. C08G 18/38; C08G 18/08; C09D 11/54; C09D 11/38; C09D 11/322; C09D 11/102; D06P 1/52; D06P 1/667; D06P 5/30

(52) U.S. Cl. CPC C08G 18/388; C08G 18/0804; C08G 18/0866; C09D 11/54; C09D 11/38; C09D 11/322; C09D 11/102; D06P 1/5285; D06P 1/667; D06P 5/30

(57) ABSTRACT

A phosphonium-containing polyurethane composition can include an aqueous liquid vehicle including water, organic co-solvent, and surfactant, and polyurethane particles including a polyurethane polymer with a polyurethane backbone. The polyurethane polymer can have pendant side chain groups along the polyurethane backbone as well as end cap groups terminating the polyurethane polymer. The pendant side chain groups and the end cap groups can collectively include aliphatic phosphonium salts and polyalkylene oxides.

### BACKGROUND

Inkjet printing has become a popular way of recording images on various media. Some of the reasons include low printer noise, variable content recording, capability of high-speed recording, and multi-color recording. These advantages can be obtained at a relatively low price to consumers. As the popularity of inkjet printing increases, the types of use also increase providing demand for new print media, for example.

### BRIEF DESCRIPTION OF DRAWINGS

FIGS. 1A and 1B schematically illustrate two examples of phosphonium-containing polyurethane compositions in accordance with the present disclosure;

FIG. 2 schematically illustrates an example fluid set in accordance with the present disclosure;

FIG. 3 provides a flow diagram for an example method of printing in accordance with the present disclosure; and

FIGS. 4-7 show schematic portions of example polyurethane polymers and polyurethane particles present in phosphonium-containing polyurethane compositions in accordance with the present disclosure.

### DETAILED DESCRIPTION

In accordance with examples of the present disclosure, a phosphonium-containing polyurethane composition includes an aqueous liquid vehicle including water, organic co-solvent, and surfactant. The phosphonium-containing polyurethane composition further includes polyurethane particles including a polyurethane polymer with a polyurethane backbone. The polyurethane polymer in this example includes pendant side chain groups along the polyurethane backbone as well as end cap groups terminating the polyurethane polymer. The pendant side chain groups and the end cap groups collectively include aliphatic phosphonium salts and polyalkylene oxides. In one specific example, the pendant side chain groups can include the aliphatic phosphonium salts and the end cap groups include the polyalkylene oxides. In another example, the pendant side chain groups can include the polyalkylene oxides and the end cap groups include the aliphatic phosphonium salts. The aliphatic phosphonium salts can include, for example, a trialkylphosphonium salt with the three alkyl groups independently including a C1 to C5 straight or branched carbon chain. In another example, the polyalkylene oxides include polyethylene oxides, polypropylene oxides, or a combination thereof. In this example, the polyalkylene oxides can independently have a number average molecular weight from 500 Mn to 15,000 Mn. The polyurethane backbone can include urethane linkage groups formed by reacting polymeric polyols with 2,2,4-trimethylhexane-1,6-diisocyanate; 2,4,4-trimethylhexane-1,6-diisocyanate (TMDI); hexamethylene diisocyanate (HDI); methylene diphenyl diisocyanate (MDI); isophorone diisocyanate (IPDI); 1-Isocyanato-4-[(4-isocyanatocyclohexyl)methyl]cyclohexane (H12MDI); or a combination thereof.

In another example, a fluid set includes an ink composition comprising an aqueous ink vehicle and a pigment dispersed therein. The fluid set in this example also includes a phosphonium-containing polyurethane composition including an aqueous liquid vehicle comprising water, organic co-solvent, and surfactant, and further comprising polyurethane particles. The polyurethane particles include a polyurethane polymer with a polyurethane backbone, the polyurethane polymer having pendant side chain groups along the polyurethane backbone as well as end cap groups terminating the polyurethane polymer. The pendant side chain groups and the end cap groups collectively include aliphatic phosphonium salts and polyalkylene oxides in this example.

In one more specific example, ink composition can further include polymer binder particles. In further detail regarding the phosphonium-containing polyurethane composition, pendant side chain groups of the polyurethane particles can include the aliphatic phosphonium salts and the end cap groups include the polyalkylene oxides. Alternatively, the pendant side chain groups of the polyurethane particles can include the polyalkylene oxides and the end cap groups include the aliphatic phosphonium salts. The aliphatic phosphonium salts of the polyurethane particles include a trialkylphosphonium salt with the three alkyl groups independently including a C1 to C5 straight or branched carbon chain. The polyalkylene oxides of the polyurethane particles can include, for example, polyethylene oxides, polypropylene oxides, or a combination thereof. The polyalkylene oxides can independently have a number average molecular weight from 500 Mn to 15,000 Mn. In further detail, the polyurethane backbone of the polyurethane particles includes urethane linkage groups formed by reacting polymeric polyols with 2,2,4-trimethylhexane-1,6-diisocyanate; 2,4,4-trimethylhexane-1,6-diisocyanate; hexamethylene diisocyanate; methylene diphenyl diisocyanate; isophorone diisocyanate; 1-Isocyanato-4-[(4-isocyanatocyclohexyl)methyl]cyclohexan; or a combination thereof.

In another example, a method of printing includes jetting a phosphonium-containing polyurethane composition onto a media substrate, the phosphonium-containing polyurethane composition including an aqueous liquid vehicle and polyurethane particles, the polyurethane particles including a polyurethane polymer with a polyurethane backbone, the polyurethane polymer having pendant side chain groups along the polyurethane backbone as well as end cap groups terminating the polyurethane polymer, wherein the pendant side chain groups and the end cap groups collectively include aliphatic phosphonium salts and polyalkylene oxides. The method in this example further includes jetting an ink composition onto the media substrate that includes a pigment and an aqueous ink vehicle. After jetting the phosphonium-containing polyurethane composition and the ink composition, the phosphonium-containing polyurethane composition and the ink composition are in contact on the media substrate. In one example, the media substrate can be a fabric substrate.

It is noted that when discussing the phosphonium-containing polyurethane composition, fluid sets, and/or methods of printing, these discussions can be considered applicable to one another whether or not they are explicitly discussed in the context of that example. Thus, for example, when discussing polyurethane backbones related to the phosphonium-containing polyurethane compositions, such disclosure is also relevant to and directly supported in the context of the fluid sets and methods, and vice versa. It is also understood that terms used herein will take on their ordinary meaning in the relevant technical field unless specified otherwise. In some instances, there are terms defined more specifically throughout the specification or included at the end of the present specification, and thus, these terms have a meaning as described herein.

The term “phosphonium-containing polyurethane composition” refers to fluid dispersion compositions that can be printed on a media substrate, such as fabric or other suitable print media substrate. In one example, the phosphonium-containing polyurethane composition can be used as a fixer to be underprinted or overprinted with respect to an ink composition. Phosphonium-containing polyurethane compositions can be prepared from a dispersions of polyurethane particles which include polyurethane polymer with both aliphatic phosphonium salts and polyalkylene oxides attached to the polyurethane polymer, e.g., as end cap groups and/or as pendant side chain groups.

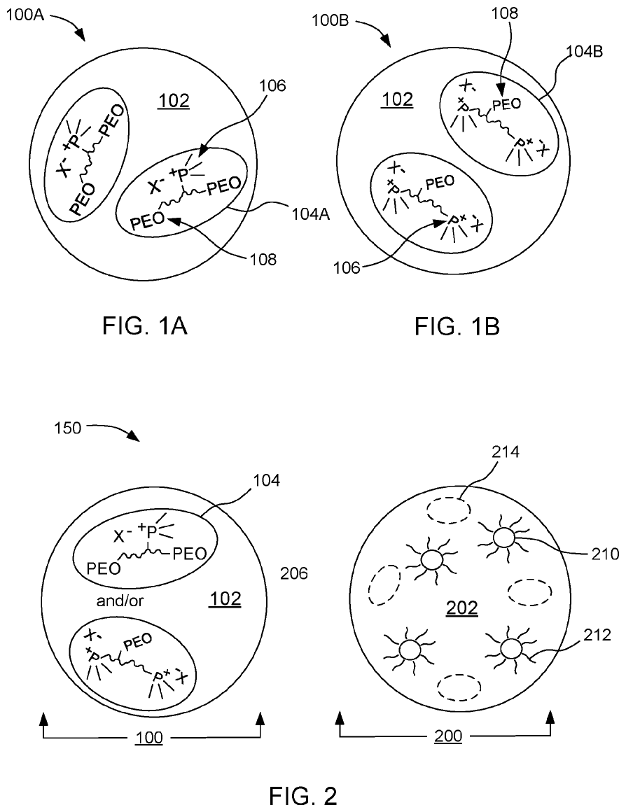

Turning now to more specific detail regarding various phosphonium-containing polyurethane compositions 100A, 100B, as shown in FIGS. 1A and 1B, respectively, the phosphonium-containing polyurethane composition can include liquid vehicle 102 and polyurethane particles 104A, 104B dispersed therein. The liquid vehicle can be an aqueous liquid vehicle including water, organic co-solvent, and surfactant. The polyurethane particles can include polyurethane polymers with polyurethane backbones, but in one example as shown schematically in FIG. 1A, pendant side chain groups can include aliphatic phosphonium salts 106 and end cap groups include the polyalkylene oxides 108. In another example, as shown schematically in FIG. 1B, the pendant side chain groups can include polyalkylene oxides 108 and the end cap groups include aliphatic phosphonium salts 106. In the example shown, the polyalkylene oxide is shown schematically as abbreviated PEO, but it is noted that the polyalkylene oxide may be a polyethylene oxide, a polypropylene oxide, or may include a combination polyethylene oxide and polypropylene oxide moieties. Also, in the example shown, a cationic “P” group is shown with multiple methyl groups, but it is understood that these may be short chain alkyl groups, such as from C1 to C5 branched or straight-chained alkyl. Other variations of these polyurethane backbone pendant groups (in the form of either end caps and/or side chains) can also be used, or combinations of polyurethane polymers, or polyurethane polymers with pendent side groups and/or end cap groups, etc., can be used, which are not shown specifically in these examples.

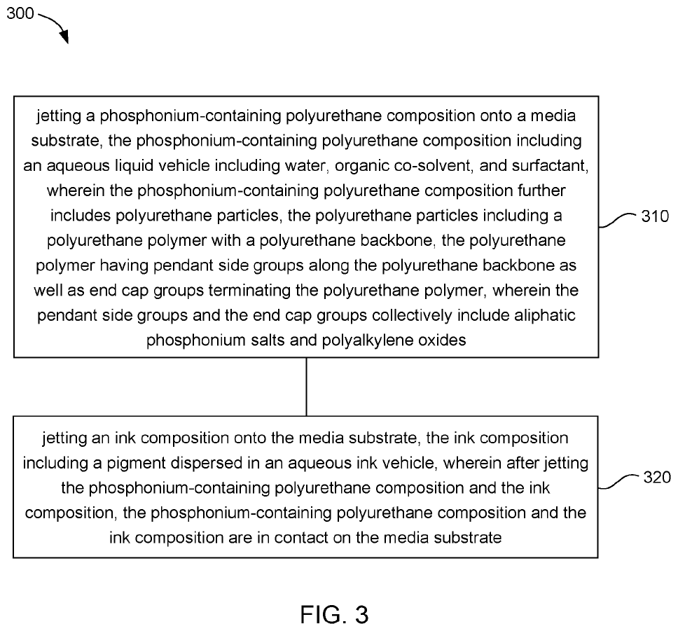

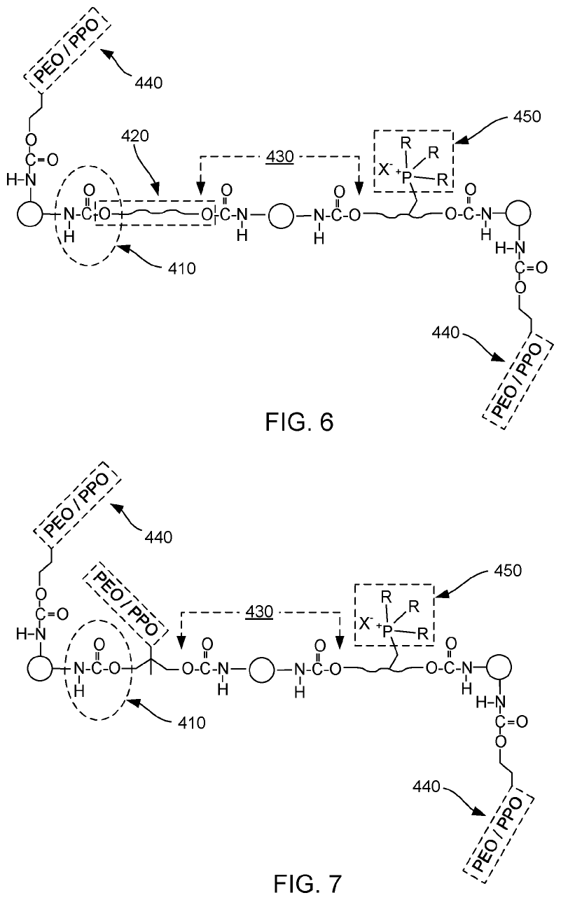

Turning now to FIG. 2, a fluid set 150 for printing, such as printing on a print media substrate, e.g., fabric, can include an ink composition 200 and a phosphonium-containing polyurethane composition 100. In this example, the ink composition include an aqueous ink vehicle 202, which can include water, organic co-solvent, and surfactant, and can also include a pigment 210, which can be dispersed by a dispersant 212, e.g., polymer or oligomer dispersant, small molecule dispersant, etc., adsorbed on, associated with, or attached to a surface of the pigment, and can be suitable for fluidjet ejection from an inkjet printer, e.g., thermal inkjet printhead ejection. In the example shown, the phosphonium-containing polyurethane composition is shown by example as including both polyurethane particle 104A and 104B, as described previously in FIG. 1, but could be polyurethane particle 104A, 104B, or some other variety of polyurethane particle with both polyalkylene oxides and aliphatic phosphonium salts as pendant side chain groups and end cap groups. In further detail as shown in FIG. 2, in this specific example, a dashed circle is shown indicating that the ink composition, in some instances, can include other solids 214 in addition to the pigment, such as polymer binder particles, particulate fillers, crosslinking agents, or other solids. For example, the ink composition may include acrylic-based latex binder, a polyurethane binder, or the like, dispersed in the aqueous ink vehicle. To be clear, the “polyurethane binder particles” are not the same as the polyurethane particles present in the phosphonium-containing polyurethane composition, as those polyurethane particles include both the aliphatic phosphonium salts and the polyalkylene oxides collectively in the form of pendant side chains and end cap groups, such as that shown schematically hereinafter in FIGS. 4-7.

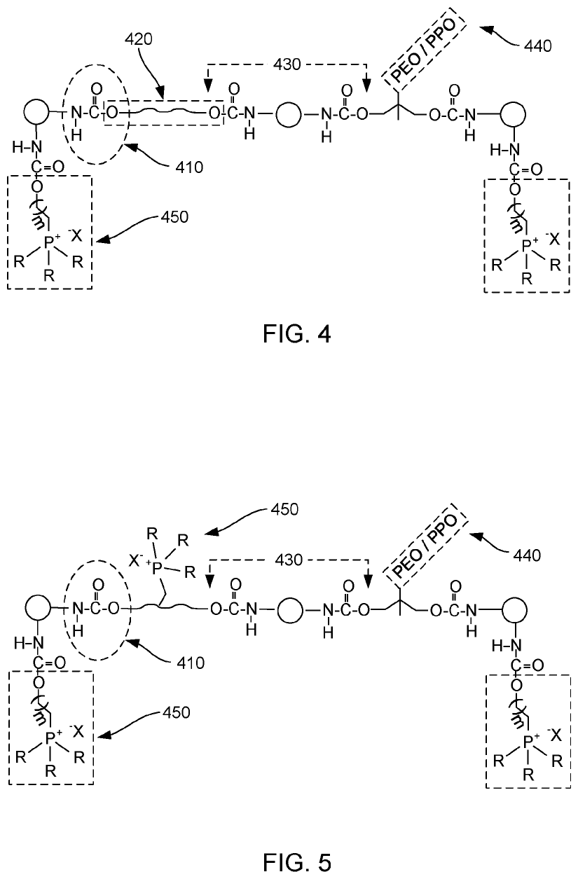

FIG. 3 depicts a method 300 of printing, which can include jetting 310 a phosphonium-containing polyurethane composition onto a media substrate. The phosphonium-containing polyurethane composition can include an aqueous liquid vehicle including water, organic co-solvent, and surfactant, and can further include polyurethane particles. The polyurethane particles can include polyurethane polymer with a polyurethane backbone, the polyurethane polymer having pendant side chain groups along the polyurethane backbone as well as end cap groups terminating the polyurethane polymer. The pendant side chain groups and the end cap groups collectively include aliphatic phosphonium salts and polyalkylene oxides. The method can also include jetting 320 an ink composition, which includes polymer binder and a pigment dispersed in an aqueous ink vehicle, onto the media substrate. After jetting the phosphonium-containing polyurethane composition and the ink composition, the phosphonium-containing polyurethane composition and the ink composition can be in contact on the media substrate, e.g., phosphonium-containing polyurethane composition underprinted and/or overprinted with respect to the ink composition.

FIGS. 4-7 provide example schematic representations of portions of polyurethane particles that can be formed in accordance with the present disclosure. As an initial matter in regard to the example schematic structures shown in FIGS. 4-7, m can be from 1 to 18, from 1 to 14, from 1 to 10, from 2 to 18, from 2 to 10, from 1 to 5, or from 2 to 5, for example. R can independently be straight-chained or branched C1 to C5 or C2 to C5 alkyl, and X can be any counterion suitable for the positively charged phosphorus atom of the phosphonium salt end cap group, such as CI, Br, I, sulfonate, p-toluenesulfonate, trifluoromethanesulfonate, etc.

The weight average molecular weight of the polyurethane polymers present in the polyurethane particles can be from 5,000 Mw to 500,000 Mw, from 10,000 Mw to 400,000 Mw, from 20,000 Mw to 250,000 Mw, from 10,000 Mw to 200,000 Mw, or from 50,000 Mw to 500,000 Mw, as measured by gel permeation chromatography, for example.

The polyurethane particles included in the context of the present disclosure can have a D50 particle size from 20 nm to 500 nm, from 20 nm to 200 nm, from 40 nm to 400 nm, from 60 nm to 300 nm, or from 100 nm to 500 nm, for example. “D50” particle size is defined as the particle size at which about half of the particles are larger than the D50 particle size and about half of the other particles are smaller than the D50 particle size (by weight based on the particle content of the particles being sized). As used herein, particle size with respect to the polyurethane particles can be based on volume of the particle size normalized to a spherical shape for diameter measurement. Particle size information can also be determined and/or verified using a scanning electron microscope (SEM).

With further reference to FIGS. 4-7, several chemical moieties are schematically shown by way of example, including urethane linkage groups 410 (formed from isocyanate groups reacted with any of a number of polyols that may be present). For example, the polyols 420 are shown schematically after polymerization. These polyols can be in the form of polymeric diols or short chained diols that may include pendant polyalkylene oxides and pendant aliphatic phosphonium salts, etc., or other types of polyols. The polyols can be reacted with isocyanates to form the urethane linkage groups. In more specific detail, the urethane linkage groups along a backbone of the polyurethane polymer can be formed by reacting these or other polyols with diisocyanates, which are shown at 430 as a backbone group after reaction with hydroxyl groups of the two adjacent compounds. The diisocyanates, shown as polymerized along the polyurethane backbone, are schematically represented by a circle with isocyanate groups on either side thereof.

In examples herein, there are two types of pendent groups that characterize the polyurethane polymers described herein, which are shown in FIGS. 4-7 at various locations, namely a polyalkylene oxide 440 and an aliphatic phosphonium salt 450. In these FIGS, “PEO” refers to polyethylene oxide, “PPO” refers to polypropylene oxide, and “PEO/PPO” indicates that the polyalkylene oxide can be polyethylene oxide, polypropylene oxide, or include both types of monomeric units as a hybrid polyalkylene.

In more specific detail, as shown in FIG. 4, the end caps in this example are in the form of aliphatic phosphonium salts 450. The polyalkylene oxides 440, on the other hand, are included as a pendant side chain group. FIG. 5, on the other hand, by way of example, includes end caps groups in the form of aliphatic phosphonium salts 450, with both polyalkylene oxides 440 and aliphatic phosphonium salts included as a pendant side chain group. The example of FIG. 6 includes polyalkylene oxides 440 as the end cap groups, and on this particular polyurethane polymer strand, the aliphatic phosphonium salt 450 is included as a pendant side chain group. FIG. 7, as another example, includes two polyalkylene oxides 440 as the end cap groups, and both polyalkylene oxide and aliphatic phosphonium salt 450 pendant side chain groups.

In accordance with examples of the present disclosure, these and other types of polyurethane particles prepared in accordance with the present disclosure can include polyurethane polymers with an acid number from 0 to 10 mg KOH/g, from 0 to 5 mg KOH/g, or 0 mg KOH/g. The term “acid value” or “acid number” refers to the mass of potassium hydroxide (KOH) in milligrams that can be used to neutralize one gram of substance (mg KOH/g), such as the various polymers disclosed herein. This value can be determined, in one example, by dissolving or dispersing a known quantity of a material in organic solvent and then titrating with a solution of potassium hydroxide (KOH) of known concentration for measurement.

It is noted that the structures shown in FIGS. 4-7 are not intended to depict specific polymers, but rather show examples of the types of groups that may be present along the polyurethane backbone and/or end caps of the polyurethane particles or blends of polyurethane polymers present in a polyurethane particle. For example, there may be additional polymerized polymeric diols, polymerized isocyanates, urethane linkage groups, polyalkylene oxides, or even other moieties not shown in this example, such as epoxides, organic acids, etc. provided by other diols. Examples of other types of compounds that can be used include various organic acid diols, C2-C20 aliphatic diols, glycidyl-containing diols to generate epoxy functional groups, functional amine groups derived from isocyanate groups that do not form a urethane linkage group, acid groups introduced from sulfonic acid or carboxylic acid diamines, or the like. These and other types of moieties can be included.

Example diisocyanates that can be used to prepare the pre-polymer (used subsequently to form the polyurethane particles) include 2,2,4 (or 2,4,4)-trimethylhexane-1,6-diisocyanate (TMDI), hexamethylene diisocyanate (HDI), methylene diphenyl diisocyanate (MDI), isophorone diisocyanate (IPDI), and/or 1-Isocyanato-4-[(4-isocyanatocyclohexyl)methyl]cyclohexane (H12MDI), etc., or combinations thereof, as shown below. Others can likewise be used alone, or in combination with these diisocyanates, or in combination with other diisocyanates not shown.

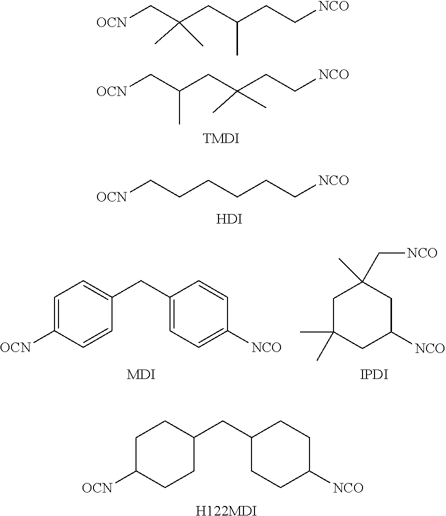

In further detail, to react with the isocyanates to form the urethane linkage groups, there can be mono-alcohols and polyols included. These alcohols can include the polyalkylene oxides and/or aliphatic phosphonium salts.

As mentioned, polyalkylene oxides can be included, for example, as pendant groups in the form of side chain groups or end cap groups. As mentioned, the polyalkylene oxides can include polyethylene oxide (PEO), polypropylene oxide (PPO), or a hybrid of both PEO and PPO, which includes both types of monomeric units as a hybrid polyalkylene. These polyalkylene oxides can be grafted or copolymerized during formation of a polyurethane pre-polymer to provide polyalkylene oxide moieties along the backbone or can be added at the end by reacting them with end isocyanate groups to form polyalkylene oxide end cap groups. Either way the polyalkylene oxide moieties can have a number average molecular weight (Mn) from 200 Mn to 15,000 Mn, from 500 Mn to 15,000 Mn, from 1,000 Mn to 12,000 Mn, from 2,000 Mn to 10,000 Mn, or from 3,000 Mn to 8,000 Mn, which can be measured by gel permeation chromatography.

In further detail, the aliphatic phosphonium salts can be included, for example, as pendant groups in the form of side chain groups or end cap groups. In preparation for incorporating the aliphatic phosphonium salt into the polyurethane backbone of the polyurethane polymer, the aliphatic phosphonium salt can be prepared by the following reaction scheme (Equation 1), which provides a general method of making various aliphatic phosphonium salt-based diols. More specifically, the following is an example reaction of an alkyl phosphine (I) with a halogenated primary alcohol (II) at a high temperature, e.g., 100° C., to give a trialkylphosphonium salt-based alcohol (III).

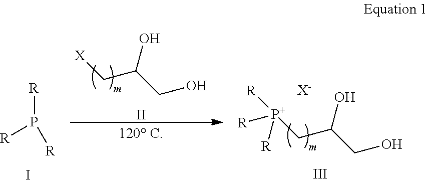

where R can independently be straight-chained or branched C1 to C5 or C2 to C5 alkyl; m can be from 1 to 18, from 1 to 14, from 1 to 10, from 2 to 18, from 2 to 10, from 1 to 5, or from 2 to 5; and X can be any suitable counterion for the positively charged phosphorus atom, such as bromide, chloride, or iodide, sulfonate, p-toluenesulfonate, trifluoromethanesulfonate, for example. Based on the general reaction scheme shown above as Equation 1, large numbers of example aliphatic phosphonium salt-based diols can be synthesized for inclusion as side chain pendant groups along the polyurethane backbone. In accordance with that shown in Equation 1, several example trialkylphosphonium salt-based diols can be formed, as shown below:

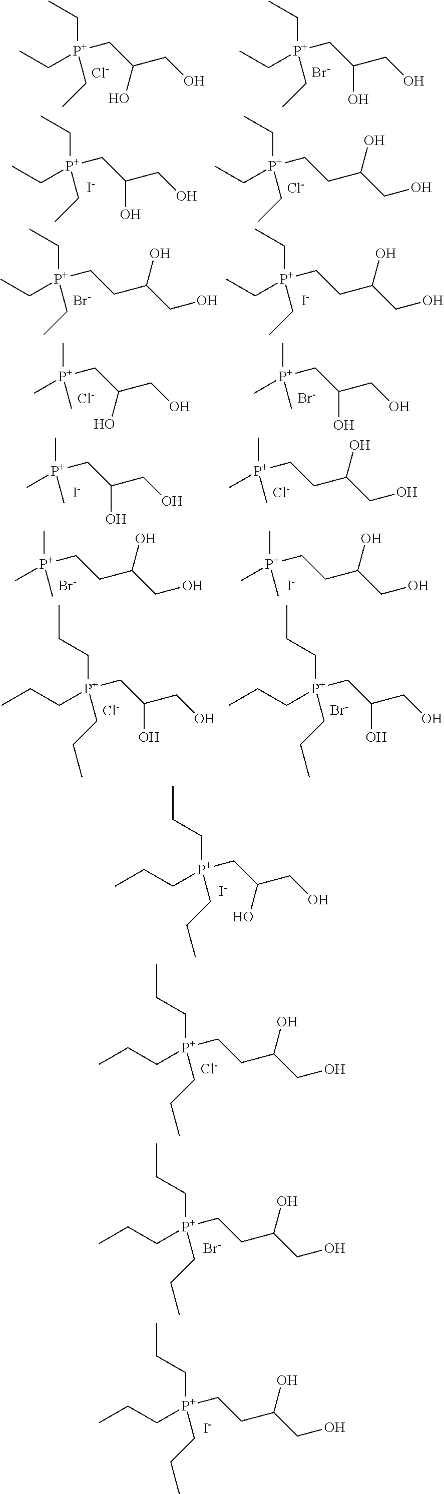

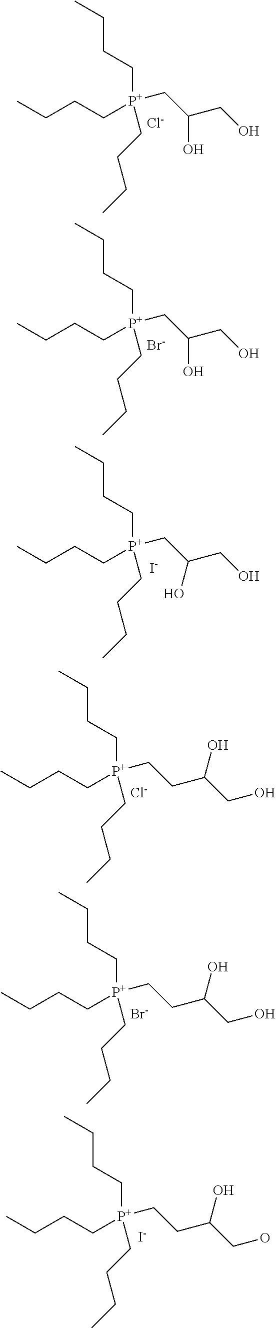

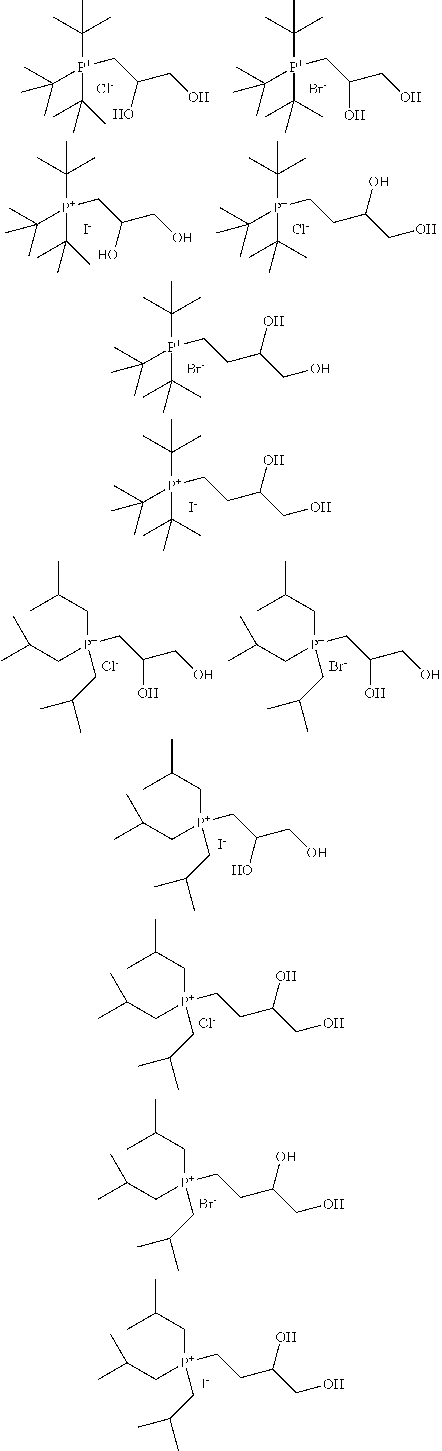

If preparing compounds including an aliphatic phosphonium salt as an end cap group, mono-alcohols can be prepared, in accordance with the following (Equation 2):

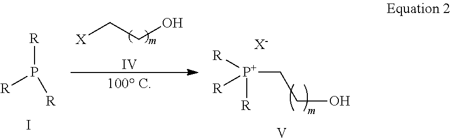

where R can independently be straight-chained or branched C1 to C5 or C2 to C5 alkyl; m can be from 1 to 18, from 1 to 14, from 1 to 10, from 2 to 18, from 2 to 10, from 1 to 5, or from 2 to 5; and X can be any suitable counterion for the positively charged phosphorus atom, such as bromide, chloride, or iodide, sulfonate, p-toluenesulfonate, trifluoromethanesulfonate, for example. Based on the general reaction scheme shown above as Equation 2, large numbers of example aliphatic phosphonium salt-based alcohols can be synthesized for inclusion as an end cap group on the polyurethane polymer. For example, when R is C1 to C5 alkyl, several example trialkylphosphonium salt-based alcohols can be formed, as shown below:

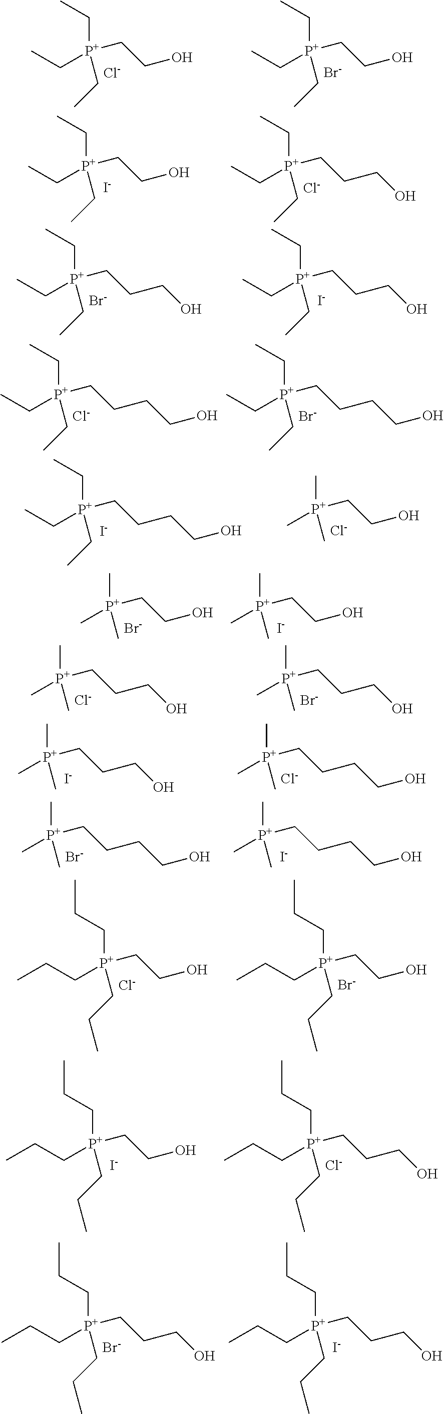

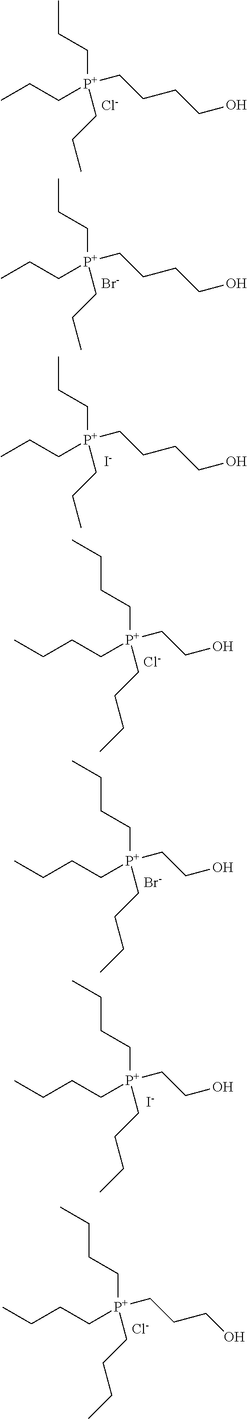

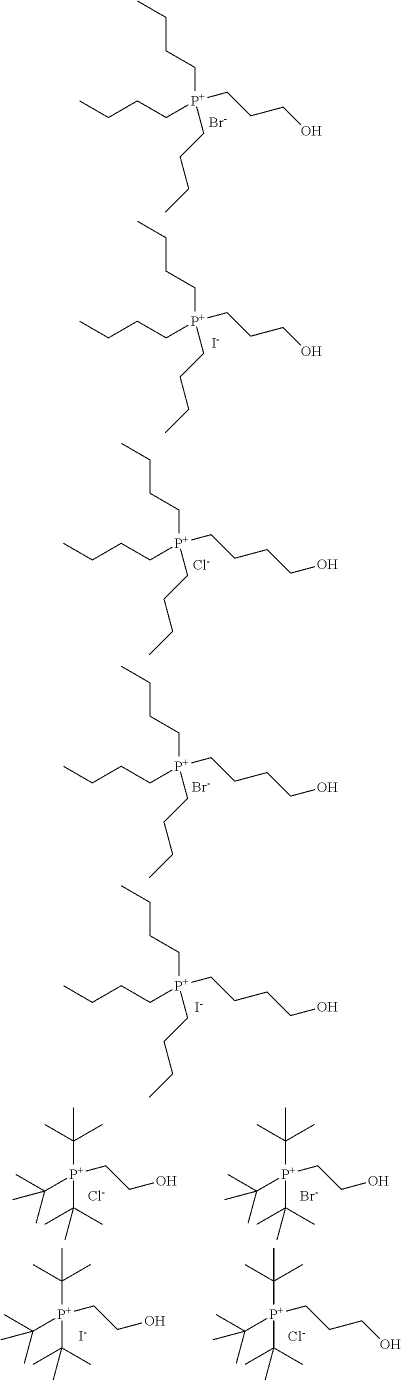

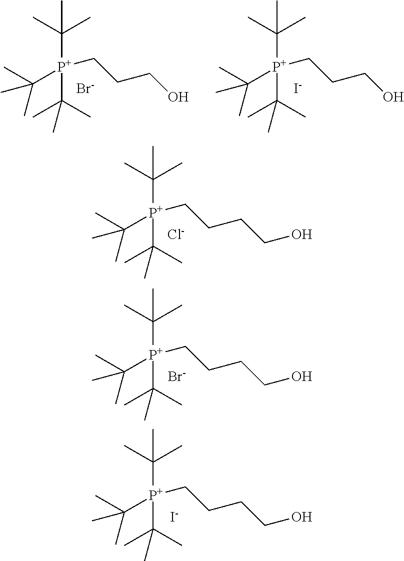

In further detail, in some examples, the polyurethane polymers of the polyurethane particles can be prepared with polymeric portions from any of a number of other types of polymeric diols. Example polymeric diols that can be used include polyether diols (or polyalkylene diols), such as polyethylene oxide diols, polypropoylene oxide diols (or a hybrid diol of polyethylene oxide and polypropylene oxide), orpolytetrahydrofuran. Other polymeric diols that can be used include polyester diols, such as polyadipic ester diol, polyisophthalic acid ester diol, polyphthalic acid ester diol; or polycarbonate diols, such as hexanediol based polycarbonate diol, pentanediol based polycarbonate diol, hybrid hexanediol and pentanediol based polycarbonate diol, etc. Combinations of polymeric diols can also be used to prepare polyurethanes such as polycarbonate ester polyether-type polyurethanes, or other hybrid-types of polyurethane particles. In one specific example, however, the polyurethane particles prepared can be polyester polyurethanes. In forming the pre-polymer, the reaction between the polymeric diols and the isocyanates can occur in the presence of a catalyst in acetone under reflux. The resultant pre-polymer may include polymerized polymeric diols and polymerized isocyanates with urethane linkage groups along the polymer. In some specific examples, other reactants may also be used as mentioned (other types of diols, amines, etc.).

The following includes preparative examples that can be used to form polyurethane particles with polyalkylene oxides and/or aliphatic phosphonium salts. These different types of pendant groups are both present on the polyurethane polymer and can both or either be included as side chain groups or pendant end cap groups, depending on their chemistry and/or time of inclusion into the reaction mixture. In accordance with this, a preparative reaction process is provided by example, and should not be considered limiting. To illustrate, in one example, the polyurethane particles prepared for use in the phosphonium-containing polyurethane compositions can be prepared by forming a pre-polymer with polyalkylene oxide pendant side chain groups. The pre-polymer can be formed more specifically by reacting a diisocyanate with a polyalkylene oxide diol in the presence of a catalyst in acetone under reflux to give the pre-polymer (which includes isocyanate end groups with polyalkylene oxide side chains positioned along a polyurethane backbone). After the pre-polymer is formed, an alkyl phosphonium salt with a single hydroxyl group, such as a triphenylphosphonium-based alcohol, can be reacted with the isocyanate end groups of the pre-polymer to form end cap groups along a portion of the polyurethane polymers of the polyurethane particles. In this example, more water can be added, and the organic solvent can be removed by vacuum distillation, for example, to provide polyurethane particles that can be stable in water and flame retardant as a media coating layer. Alternatively, the aliphatic phosphonium salt in the form of a diol to form the pre-polymer including aliphatic phosphonium salt pendant side chain groups, and then the pre-polymer can be reacted with polyalkylene oxides associated with a single hydroxyl group to form the end cap groups.

In some examples, polyurethane pre-polymer can be prepared with an NCO/OH ratio from 1.2 to 2.2. In another example, the polyurethane pre-polymer can be prepared with an NCO/OH ratio from 1.4 to 2.0. In yet another example, the polyurethane pre-polymer can be prepared using an NCO/OH ratio from 1.6 to 1.8. In further detail, the weight average molecular weight of the polyurethane pre-polymer can range from 5,000 Mw to 500,000 Mw, 5,000 Mw to 400,000 Mw, or from 10,000 Mw to 300,000 Mw, as measured by gel permeation chromatography. In another example, the weight average molecular weight of the polyurethane pre-polymer can range from 40,000 Mw to 180,000 Mw, or from 60,000 Mw to 140,000 Mw, also as measured by gel permeation chromatography, for example.

In further detail and by way of example, the phosphonium-containing polyurethane compositions of the present disclosure can be formulated as a fluid-jettable formulation that is digitally ejectable from a thermal inkjet printhead, a piezo inkjet printhead, or by some other digital ejection technology. In one example, the phosphonium-containing polyurethane composition can be formulated to be ejectable from a thermal inkjet printhead. Furthermore, the phosphonium-containing polyurethane compositions of the present disclosure can be suitable for use as a fixer fluid or composition to be printed with a pigmented ink composition. This can provide printed images with good bleed control when printed on a media substrate, even a textile or fabric print substrate as a fixer fluid or composition that can be overprinted or underprinted with respect to the ink composition (or printed in alternating layers). That stated, the phosphonium-containing polyurethane compositions described herein can be suitable for use with many types of print media, including paper, fabric, plastic, e.g., plastic film, metal, e.g., metallic foil, and other types of printable substrates, including combinations and/or composites thereof. In particular, printing on textiles or fabrics can benefit from use of the phosphonium-containing polyurethane compositions of the present disclosure.

Example fabric or textile substrates that can be used with the phosphonium-containing polyurethane compositions described herein include cotton fibers, treated and untreated cotton substrates, polyester substrates, nylons, blended substrates thereof, etc. It is notable that the term “fabric substrate” or “fabric print media substrate” does not include print media substrate materials such as any paper (even though paper can include multiple types of natural and synthetic fibers or mixtures of both types of fibers). Example natural fiber fabrics that can be used include treated or untreated natural fabric textile substrates, e.g., wool, cotton, silk, linen, jute, flax, hemp, rayon fibers, thermoplastic aliphatic polymeric fibers derived from renewable resources such as cornstarch, tapioca products, or sugarcanes, etc. Example synthetic fibers that can be used include polymeric fibers such as nylon fibers (also referred to as polyamide fibers), polyvinyl chloride (PVC) fibers, PVC-free fibers made of polyester, polyamide, polyimide, polyacrylic, polypropylene, polyethylene, polyurethane, polystyrene, polyaramid, e.g., Kevlar® (E. I. du Pont de Nemours Company, USA), polytetrafluoroethylene, fiberglass, polytrimethylene, polycarbonate, polyethylene terephthalate, polyester terephthalate, polybutylene terephthalate, or a combination thereof. In some examples, the fiber can be a modified fiber from the above-listed polymers. The term “modified fiber” refers to one or both of the polymeric fiber and the fabric as a whole having undergone a chemical or physical process such as, but not limited to, copolymerization with monomers of other polymers, a chemical grafting reaction to contact a chemical functional group with one or both of the polymeric fiber and a surface of the fabric, a plasma treatment, a solvent treatment, acid etching, or a biological treatment, an enzyme treatment, or antimicrobial treatment to prevent biological degradation.

Thus, the fabric substrate can include natural fiber and synthetic fiber, e.g., cotton/polyester blend. The amount of each fiber type can vary. For example, the amount of the natural fiber can vary from 5 wt % to 95 wt % and the amount of the synthetic fiber can range from 5 wt % to 95 wt %. In yet another example, the amount of the natural fiber can vary from 10 wt % to 80 wt % and the synthetic fiber can be present from 20 wt % to 90 wt %. In other examples, the amount of the natural fiber can be 10 wt % to 90 wt % and the amount of the synthetic fiber can also be 10 wt % to 90 wt %. Likewise, the ratio of natural fiber to synthetic fiber in the fabric substrate can vary. For example, the ratio of natural fiber to synthetic fiber can be 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, or vice versa. The fabric substrate can be in one of many different forms, including, for example, a textile, a cloth, a fabric material, fabric clothing, or other fabric product suitable for applying ink, and the fabric substrate can have any of a number of fabric structures, including structures that can have warp and weft, and/or can be woven, non-woven, knitted, tufted, crocheted, knotted, and pressured, for example. The terms “warp” as used herein, refers to lengthwise or longitudinal yarns on a loom, while “weft” refers to crosswise or transverse yarns on a loom.

The basis weight of the print media, such as the paper, fabric, plastic film, foil, etc., can be from 20 gsm to 500 gsm, from 40 gsm to 400 gsm, from 50 gsm to 250 gsm, or from 75 gsm to 150 gsm, for example. Some print media substrates can be toward the thinner end of the spectrum, and other print media substrates may be thicker, and thus, the weight basis ranges given are provided by example, and are not intended to be limiting.

Regardless of the print media substrate used, such substrates can contain or be coated with additives including, but not limited to, colorant (e.g., pigments, dyes, and tints), antistatic agents, brightening agents, nucleating agents, antioxidants, UV stabilizers, and/or fillers and lubricants, for example. Alternatively, the print media substrates may be pre-treated in a solution containing the substances listed above before applying other treatments or coating layers.

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight ratio range of about 1 wt % to about 20 wt % should be interpreted to include not only the explicitly recited limits of about 1 wt % and about 20 wt %, but also to include individual weights such as 2 wt %, 11 wt %, 14 wt %, and sub-ranges such as 10 wt % to 20 wt %, 5 wt % to 15 wt %, etc.

### EXAMPLES

The following examples illustrate the technology of the present disclosure. However, it is to be understood that the following is merely illustrative of the methods and systems herein. Numerous modifications and alternative methods and systems may be devised without departing from the present disclosure. Thus, while the technology has been described above with particularity, the following provides further detail in connection with what are presently deemed to be the acceptable examples.

### Example 1—Synthesis of Aliphatic Phosphonium Salt-Based Diol

Hydroxylpropyltributylphosphonium chloride salt (TBPDHPCI) was prepared in accordance with Formula 1, and as further described below:

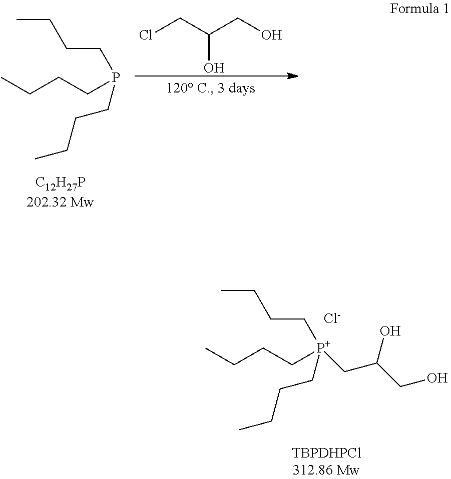 [SMILES: CCCCP(CCCC)CCCC ; OCC(O)CCl ; CCCC[P+](CCCC)(CCCC)CC(O)CO ; [Cl-]]

In accordance with Formula 1, a 500 mL four-necked flask equipped with a mechanical stirrer, a thermometer, a dropping funnel, and a condenser was purged with nitrogen, and 150 g (0.741 mol) of tri-n-butylphosphine was added. At 80° C., 86.11 g (0.779 mol) of 1-chloro-2,3-propanediol was added dropwise over 30 minutes, and the solution turned white and cloudy. The solution continued to be heated to 120° C. for 2 days under nitrogen and stirring. The reaction solution was a viscous, colorless, and transparent liquid. The presence of unreacted trialkylphosphine was tested using carbon disulphide, but trialkylphosphine was not detected. The solution was concentrated using an evaporator and then dried with a vacuum pump to give 226.03 g of a colorless and transparent viscous liquid. The titration purity was 100.0% and the yield was 97.5 wt %.

### Example 2—Synthesis of Aliphatic Phosphonium Salt-Based Mono-Alcohol

Hydroxyethyltributylphosphonium chloride salt (TBPHECI) was prepared as per Formula 2 and as further described below:

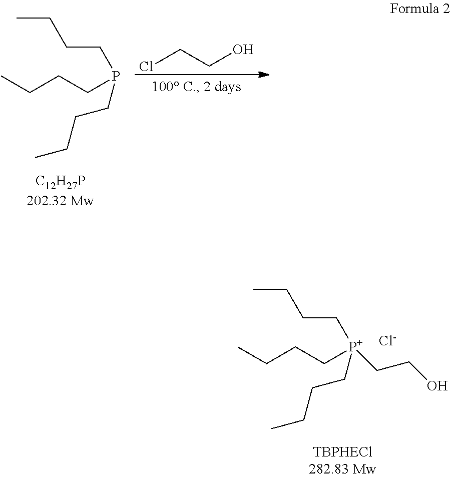

In accordance with Formula 2, a 500 mL four-necked flask equipped with a mechanical stirrer, a thermometer, a dropping funnel, and a condenser was purged with nitrogen and 150 g (0.741 mol) of tri-n-butylphosphine was added. At 80° C., 62.7 g (0.779 mol) of 2-chloroethanol was added dropwise over 30 minutes and the solution turned white and cloudy. The solution continued to be heated to 100° C. for 2 days under nitrogen and stirring. The reaction solution was very viscous but was colorless and transparent. The presence of unreacted trialkylphosphine was tested using carbon disulphide, but trlalkylphosphine was not detected. The solution was concentrated using an evaporator and then dried with a vacuum pump to give 206.4 g of a colorless and transparent viscous liquid. The titration purity was 100.0% and the yield was 98.5 wt %.

### Example 3—Preparation of Polyurethane Dispersion 1 (D1)

A polyurethane dispersion was prepared having polyalkylene oxide end caps and aliphatic phosphonium salt side chain pendant groups. In this example, 72.087 g of polyester diol (Stepanpol PC-1015-55), 11.188 g of hydrogenated m-xylenee disisocyanate (H6XDI), 6.1 g of dihydroxylpropyl triphenylphosnium chloride (TBPDHPCI), and 90 g of acetone were mixed in a 500 mL of 4-neck round bottom flask. A mechanical stirrer with glass rod and Teflon blade was attached. A condenser was attached. The flask was immersed in a constant temperature bath at 75° C. The system was kept under a drying tube. 3 drops of bismuth catalyst (Reaxis C3203) was added to initiate the polymerization. Polymerization was continued for 3 hours at 75° C. 0.5 g samples were withdrawn for % NCO titration to confirm the reaction. 10.625 g of poly(ethylene glycol) methyl ether (Mn=2000) in 10 g of acetone was added to the reactor. The polymerization was continued for 3 hours at 75° C. The polymerization temperature was reduced to 50° C. and then 209.5 g of DI water was added over 20 minutes. The solution became milky and white in color and the milky dispersion was continuously stirred overnight at room temperature. The polyurethane dispersion was filtered through a 400 mesh stainless sieve. Acetone was removed with a Rotorvap at 50° C. (add 2 drops (20mg) BYK-011 de-foaming agent). The final polyurethane dispersion was filtered through fiber glass filter paper. The particle size of the polyurethane particle was measured by Malvern Zetasizer at 431.4 nm. The pH of the dispersion was 8.5. The solids content was 29.62 wt %. The acid number was 0 mg KOH/g.

### Example 4—Preparation of Polyurethane Dispersion 2 (D2)

A polyurethane dispersion was prepared having polyalkylene oxide end caps and aliphatic phosphonium salt side chain pendant groups. In this example, 73.184 g of polyester diol (Stepanpol PC-1015-55), 11.188 g of 1,6-hexamethylene disisocyanate (HDI), 6.192 g of 2,3-dihydroxylpropyltriphenylphosnium chloride (TBPDHPCI) and 90 g of acetone were mixed in a 500 mL of a 4-neck round bottom flask. A mechanical stirrer with glass rod and Teflon blade was attached. A condenser was attached. The flask was immersed in a constant temperature bath at 75° C. The system was kept under a drying tube. 3 drops of bismuth catalyst (Reaxis C3203) was added to initiate the polymerization. Polymerization was continued for 3 hours at 75° C. 0.5 g samples were withdrawn for % NCO titration to confirm the reaction. 10.787 g of poly(ethylene glycol) methyl ether (Mn=2000) in 10 g of acetone was added to the reactor. The polymerization was continued for 3 hours at 75° C. The polymerization temperature was reduced to 50° C. and then 209.5 g of DI water was added over 20 minutes. The solution became milky and white in color and the milky dispersion was continuously stirred overnight at room temperature. The polyurethane dispersion was filtered through a 400 mesh stainless sieve. Acetone was removed with a Rotorvap at 50° C. (add 2 drops (20mg) BYK-011 de-foaming agent). The final polyurethane dispersion was filtered through fiber glass filter paper. The particle size of the polyurethane particle was measured by Malvern Zetasizer at 346.2 nm. The pH of the dispersion was 8.5. The solids content was 31.41 wt %. The acid number was 0 mg KOH/g.

### Example 5—Preparation of Polyurethane Dispersion 3 (D3)

A polyurethane dispersion was prepared having aliphatic phosphonium salt end caps and polyalkylene oxide side chain pendant groups. In this example, 38.125 g of g of Ymer™ N-120 (PEO-based diol; 1,000 Mw; from Perstorp, Sweden), 23.565 g of isophorone disisocyanate (IPDI), and 64 g of acetone were mixed in a 500 mL of 4-neck round bottom flask. A mechanical stirrer with glass rod and Teflon blade was attached. A condenser was attached. The flask was immersed in a constant temperature bath at 75° C. The system was kept under a drying tube. 3 drops of bismuth catalyst (Reaxis C3203) was added to initiate the polymerization. Polymerization was continued for 3 hours at 75° C. 0.5g of pre-polymer was withdrawn for final % NCO titration. The measured NCO value was 9.20 wt %. The theoretical % NCO should be 9.24 wt %. 38.311 g of the aliphatic phosphonium salt-based alcohol from Example 2 (hydroxyethyltributylphosphonium chloride salt) in 20 mL of acetone was added over 10 minutes. After 60 minutes, the polymerization temperature was reduced to 50° C. and then 247.811 of DI water was added over 20 minutes. The solution became milky and white in color and the milky dispersion was continuously stirred overnight at room temperature. The PUB dispersion was filtered through a 400 mesh stainless sieve. Acetone was removed with a Rotorvap at 50° C. (add 2 drops (20mg) BYK-011 de-foaming agent). The final PUB dispersion was filtered through fiber glass filter paper. The solids content was 32.57 wt %. The particle size measured by Malvern Zetasizer was 13.57 nm. The pH of the dispersion was 8.0. The acid number was 0 mg KOH/g.

### Example 6—Preparation of Polyurethane Dispersion 4 (D4)

A polyurethane dispersion was prepared having aliphatic phosphonium salt end caps and polyalkylene oxide side chain pendant groups. In this example, 24.926 g of g of Ymer™ N-120 (PEO-based diol; 1,000 Mw; from Perstorp, Sweden), 25.184 g of isophorone disisocyanate (IPDI), and 64 g of acetone were mixed in a 500 mL of 4-neck round bottom flask. A mechanical stirrer with glass rod and Teflon blade was attached. A condenser was attached. The flask was immersed in a constant temperature bath at 75° C. The system was kept under a drying tube. 3 drops of bismuth catalyst (Reaxis C3203) was added to initiate the polymerization. Polymerization was continued for 3 hours at 75° C. 0.5g of pre-polymer was withdrawn for final % NCO titration. The measured NCO value was 14.75 wt %. The theoretical % NCO should be 14.81 wt %. 49.891 g of the aliphatic phosphonium salt-based alcohol from Example 1 (hydroxylpropyltributylphosphonium chloride salt) in 20 mL of acetone was added over 10 minutes. After 60 minutes, the polymerization temperature was reduced to 50° C. and then 259.391 of DI water was added over 20 minutes. The solution became milky and white in color and the milky dispersion was continuously stirred overnight at room temperature. The PUB dispersion was filtered through a 400 mesh stainless sieve. Acetone was removed with a Rotorvap at 50° C. (add 2 drops (20mg) BYK-011 de-foaming agent). The final PUB dispersion was filtered through fiber glass filter paper. The solid content was 33.47 wt %. The particle size measured by Malvern Zetasizer was 307.1 nm. The pH of the dispersion was 8.0. The acid number was 0 mg KOH/g.

### Example 7—Alternative Preparations of Polyurethane Dispersions

Various alternative polyurethane particles can be prepared similar to that described in accordance with Examples 3-6, depending on the order of addition, the pendent groups or end groups selected for use, e.g., whether or not the pendent groups are added as diols or as mono-alcohols, etc. For example, the aliphatic phosphonium salt-based diol prepared in accordance with Example 1 and/or a PEO/PPO diol may be used together along a polyurethane backbone, with end caps provided by the aliphatic phosphonium salt-based mono-alcohol of Example 2 and/or a PEO/PPO mono-alcohol. Examples of various arrangements such as this are shown schematically in FIGS. 5 and 7.

### Example 8—Preparation of Ink Composition

An ink composition was prepared containing the following components: 6 wt % polymer binder particles (aminoalkylsulphonated polyurethane), 6 wt % glycerol, 0.6 wt % Crodafos® N3 acid (from Croda, Great Britain), 1 wt % LEG-1, 0.22 wt % Acticide® (from Thor Specialties, Inc., USA), 0.3 wt % Surfynol® 440 (from Air Products, USA), 3 wt % magenta pigment (HPF-M046; from Cabot Corp., USA), and a balance of water up to 100 wt %.

### Example 9—Preparation of Phosphonium-Containing Polyurethane Compositions (F1-F4)

Four (4) phosphonium-containing polyurethane compositions (F1-F4) were prepared that included the various phosphonium-containing polyurethane dispersions prepared in accordance with Examples 3-6. The phosphonium-containing polyurethane compositions prepared are referred to as F1 (which include the polyurethane dispersion D1), F2 (which includes polyurethane dispersion D2), F3 (which include polyurethane dispersion D3), and F4 (which include polyurethane dispersion D4). Thus, F1 and F2 included polyurethanes with polyalkylene oxide end caps and aliphatic phosphonium salt side chain pendant groups. F3 and F4 included polyurethanes with aliphatic phosphonium salt end caps and polyalkylene oxide side chain pendant groups. In further detail, the four phosphonium-containing polyurethane compositions were prepared to include the following components: 20 wt % 1,2-butanediol, 0.95 wt % Tergitol® 15-S-7 (from Dow Chemical, USA), 1 wt % succinic acid, and 2.45 wt % of the polyurethane prepared in accordance with Examples 3-6 (based on the dispersed polyurethane content therein).

### Example 10—Printhead Performance of Phosphonium-Containing Polyurethane Compositions (F2-F4)

Three (3) of the phosphonium-containing polyurethane compositions (F2-F4) prepared in accordance with Example 9 included polyurethane dispersions D2-D4, respectively, were evaluated for thermal inkjet printhead performance, e.g., missing nozzle, drop weight, drop velocity, decel, and toe curve. As mentioned, D2 included polyalkylene oxide end caps and aliphatic phosphonium salt side chain pendant groups which were used to formulate F2, and D3 and D4 both included aliphatic phosphonium salt end caps and polyalkylene oxide side chain pendant groups where used to formulate F3 and F4, respectively. A Control fixer composition was prepared that included Floquat® FL-2350, which is a quaternary polyamine (copolymer of dimethyl amine and epichlorohydrin) for comparison, rather than the polyurethane compounds of the present disclosure.

Table 1 below provides the data collected for thermal inkjet printhead performance for F2-F4 using the following protocols. Percent (%) Missing Nozzles is calculated based on the number of nozzles incapable of firing at the beginning of a jetting sequence as a percentage of the total number of nozzles on an inkjet printhead attempting to fire. Thus, the lower the percentage number, the better the Percent Missing Nozzles value. Drop Weight (DW) is an average drop weight in nanograms (ng) across the number of nozzles fired measured using a burst mode or firing at 0.75 Joules. Drop Weight 2,000 (DW 2K) is measured using a 2-drop mode of firing, firing 2,000 drops and then measuring/calculating the average ink composition drop weight in nanograms (ng). Drop Volume (DV) refers to an average velocity of the drop as initially fired from the thermal inkjet nozzles. Decel refers to the loss in drop velocity after 5 seconds of ink composition firing. “Turn On Energy” (TOE Curve) refers to the energy used to generate consistent ink composition firing.

TABLE 1
Thermal Inkjet Printhead Performance of Phosphonium-containing
Polyurethane Compositions

| | % Missing | DW | DW 2K | DV | | |
|---|---|---|---|---|---|---|
| ID | Nozzles | (ng) | (ng) | (m/s) | Decel | TOE Curve |
| F2 | 0 | 12.2 | 9.5 | 12.9 | 0.2 | Good |
| F3 | 4.2 | 12.6 | 8.3 | 12.8 | 0.2 | Good |
| F4 | 0 | 12.3 | 8.3 | 12.3 | 0.2 | Good |
| Control | 0 | 11.4 | 7.5 | 10.9 | 0 | Good |

As can be seen in Table 1, the phosphonium-containing polyurethane compositions prepared and evaluated in accordance with the present disclosure (F2-F4) all performed favorably compared to the Control fixer composition. TOE Curve data is considered “Good” when relatively lower levels of energy are used to achieve higher drop weights (DW) as measured in nanograms (ng). For example, achieving a drop weight (DW) of 9.5 ng or above at an energy level 0.75 Joule may be considered “Good” TOE (with DW getting larger with more energy input until the curve flattens out).

### Example 11—Stability Performance of Phosphonium-Containing Polyurethane Compositions F2-F4

Three (3) of the phosphonium-containing polyurethane compositions (F2-F4) prepared in accordance with Example 9 included polyurethane dispersions D2-D4, respectively, were evaluated for stability, e.g., pH and viscosity. As mentioned, D2 included polyalkylene oxide end caps and aliphatic phosphonium salt side chain pendant groups which were used to formulate F2, and D3 and D4 both included aliphatic phosphonium salt end caps and polyalkylene oxide side chain pendant groups where used to formulate F3 and F4, respectively.

Table 2 below illustrates the viscosity and pH stability of the phosphonium-containing polyurethane compositions (F2-F4) that contained the polyurethane particles of dispersions D2-D4, respectively. Viscosity and pH stability were evaluated using accelerated shelf-life (ASL) and freeze-thaw (T-cycle) data. The ASL data was collected before and after 1 week of storage at 60° C. The % Δ viscosity and the Δ pH data below relates to a comparison prior to ASL storage to that one (1) week of storage at 60° C. The T-cycle data was collected using 5 freeze-thaw cycles where 30 mL samples were brought to an initial temperature of 70° C. in 20 minutes, and then maintained at 70° C. for 4 hours. The samples were then decreased from 70° C. to −40° C. in 20 minutes and maintained at −40° C. for 4 hours. This process was repeated, such that each sample was subjected to a total of 5 freeze-thaw cycles. Following the fifth cycle, the samples were allowed to equilibrate to room temperature. The % Δ viscosity and the Δ pH data indicates the change in viscosity and pH from before the T-cycle challenge.

TABLE 2
ASL and T-cycle Stability (viscosity and pH) of phosphonium-
containing Polyurethane Compositions

| | ASL | | T-cycle | |
|---|---|---|---|---|
| ID | % Δ viscosity | Δ pH | % Δ viscosity | Δ pH |
| F2 | 0 | −0.02 | 0 | −0.08 |
| F3 | 0 | −0.06 | −4.2 | −0.15 |
| F4 | 0 | −0.07 | 0 | −0.12 |

As can be seen by Table 2, the stability data with respect to both viscosity and pH with both ASL and T-cycle was very good, with minimal changes and in some instances, no change.

### Example 12—Print Media Performance of Phosphonium-Containing Polyurethane Compositions F2-F4

Three (3) of the phosphonium-containing polyurethane compositions (F2-F4) prepared in accordance with Example 9 included polyurethane dispersions D2-D4, respectively, were evaluated for print media performance (on fabric), e.g., durability and bleed (Tabled 3A-3C). As mentioned, D2 included polyalkylene oxide end caps and aliphatic phosphonium salt side chain pendant groups which were used to formulate F2, and D3 and D4 both included aliphatic phosphonium salt end caps and polyalkylene oxide side chain pendant groups where used to formulate F3 and F4. For one of the fabrics evaluated, a Control fixer composition was prepared that included Floquat® FL-2350, which is a quaternary polyamine (copolymer of dimethyl amine and epichlorohydrin) for comparison, rather than the polyurethane compounds of the present disclosure.

Tables 3A-3C below illustrate the print washfastness durability of the ink composition of Example 8 when printed with phosphonium-containing polyurethane compositions (F2-F4) containing the polyurethane particles of dispersions D2-D4, respectively, compared to the use of no phosphonium-containing polyurethane composition (Tables 3A-3C) on three different fabric substrates, namely Pakistan #1 (white, 50% cotton/50% polyester), Pakistan #4 (white, 100% cotton), and Gildan 780 (white, 100% cotton), as well as compared to the use of a Control fixer on the Pakistan #1 fabric substrate. The ink composition of Example 8 was printed at 3 dots per pixel (dpp) and when a phosphonium-containing polyurethane composition or other fixer composition was used, the fixer composition was printed at 1.5 dpp. After printing, the samples were all cured for 3 minutes at 150° C.

The various printed fabric samples were measured for optical density (OD) initially after printing, and then printed fabric samples were washed 5 times with a standard washing machine, such as Sears Kenmore® 90 Series Washer, with warm water (about 40° C.) and detergent, air drying between washes. The samples were measured again for OD (after 5 washes) and L*a*b* before and after the 5 washes. After the five cycles, optical density (OD) and L*a*b* values were measured for comparison to generate a change percentage of OD, as well as calculated delta E (ΔE) values calculated using the various standards, e.g., 1976 standard (ΔE_{CIE}), 2000 standard (ΔE₂₀₀₀), 1994 standard (ΔE₉₄), as well as a 2:1 color difference standard (ΔE_{CMC} (2:1)), as follows:

TABLE 3A
Washfastness Durability on Pakistan #1 Fabric Substrate

| | | Final OD | Δ % | | | | ΔE_{CMC} |
|---|---|---|---|---|---|---|---|
| ID | Initial OD | (5 washes) | OD | ΔE_{CIE} | ΔE₂₀₀₀ | ΔE₉₄ | (2:1) |
| F2 | 1.092 | 0.856 | −21.6 | 11.1 | 5.8 | 6 | 4.5 |
| F3 | 1.138 | 0.804 | −29.4 | 15 | 8.2 | 8.5 | 6.1 |
| F4 | 1.136 | 0.835 | −26.5 | 15.8 | 8.5 | 8.8 | 6.3 |
| Control | 1.089 | 0.732 | −32.8 | 17 | 10.2 | 10.7 | 7 |
| None | 1.098 | 0.846 | −22.8 | 13.8 | 7.8 | 8.1 | 5.6 |

TABLE 3B
Washfastness Durability on Pakistan #4 Fabric Substrate

| | | Final OD | Δ % | | | | ΔE_{CMC} |
|---|---|---|---|---|---|---|---|
| ID | Initial OD | (5 washes) | OD | ΔE_{CIE} | ΔE₂₀₀₀ | ΔE | (2:1) |
| F2 | 1.126 | 0.885 | −21.4 | 10.5 | 5.6 | 5.8 | 4.3 |
| F3 | 1.031 | 0.762 | −26.1 | 15.5 | 8.8 | 9.4 | 6.4 |
| F4 | 1.141 | 0.940 | −17.6 | 9.8 | 5.1 | 5.3 | 4.1 |
| None | 1.129 | 0.895 | −20.8 | 11.6 | 6.2 | 6.4 | 4.7 |

TABLE 3C
Washfastness Durability on Gildan 780 Fabric Substrate

| | | Final OD | Δ % | | | | ΔE_{CMC} |
|---|---|---|---|---|---|---|---|
| ID | Initial OD | (5 washes) | OD | ΔE_{CIE} | ΔE₂₀₀₀ | ΔE | (2:1) |
| F2 | 1.061 | 0.915 | −13.8 | 6 | 2.9 | 3.1 | 2.7 |
| F3 | 1.085 | 0.867 | −20.4 | 10.7 | 6.1 | 6.4 | 4.6 |
| F4 | 1.071 | 0.937 | −12.5 | 7.1 | 3.8 | 4.1 | 3.1 |
| None | 1.050 | 0.913 | −13.1 | 7.6 | 3.8 | 4.1 | 3.3 |

As can be seen from FIGS. 3A-3C, the phosphonium-containing polyurethane compositions (F2-F4) can not only provide favorable or comparable initial optical density compared to the Control, but can also enhance durability in many instances as well. In addition to the favorable durability performance, including acceptable or good initial OD and washfastness, bleed control of the ink composition on the fabric substrates was significantly improved, as validated by printing on one of the example fabric substrates, e.g., Pakistan #4, with the phosphonium-containing polyurethane composition underprinted therebeneath as a fixer composition.

As a point of perspective about the data provided in Tables 3A-3C, the OD, washfastness, and bleed control may be considered collectively. Often, when a fixer composition is underprinted relative to an ink composition, the durability is often reduced as bleed control is improved. However, as the data of Tables 3A-3C shows, the durability data was comparable against the Control and when not using the phosphonium-containing polyurethane composition as an underprinting fixer composition, while at the same time, the bleed control was significantly enhanced.

What is claimed is:

1. A phosphonium-containing polyurethane composition, comprising:
an aqueous liquid vehicle including water, organic co-solvent, and surfactant; and
polyurethane particles including a polyurethane polymer with a polyurethane backbone, the polyurethane polymer having pendant side chain groups along the polyurethane backbone as well as end cap groups terminating the polyurethane polymer, wherein the pendant side chain groups and the end cap groups collectively include aliphatic phosphonium salts and polyalkylene oxides.

2. The phosphonium-containing polyurethane composition of claim 1, wherein the pendant side chain groups include the aliphatic phosphonium salts, and the end cap groups include the polyalkylene oxides.

3. The phosphonium-containing polyurethane composition of claim 1, wherein the pendant side chain groups include the polyalkylene oxides, and the end cap groups include the aliphatic phosphonium salts.

4. The phosphonium-containing polyurethane composition of claim 1, wherein the aliphatic phosphonium salts include a trialkylphosphonium salt with the three alkyl groups independently including a C1 to C5 straight or branched carbon chain.

5. The phosphonium-containing polyurethane composition of claim 1, wherein the polyalkylene oxides include polyethylene oxides, polypropylene oxides, or a combination thereof, and wherein the polyalkylene oxides independently have a number average molecular weight from 500 Mn to 15,000 Mn.

6. The phosphonium-containing polyurethane composition of claim 1, wherein the polyurethane backbone includes urethane linkage groups formed by reacting polymeric polyols with 2,2,4-trimethylhexane-1,6-diisocyanate; 2,4,4-trimethylhexane-1,6-diisocyanate; hexamethylene diisocyanate; methylene diphenyl diisocyanate; isophorone diisocyanate; 1-Isocyanato-4-[(4-isocyanatocyclohexyl)methyl]cyclohexan; or a combination thereof.

7. A fluid set, comprising:
an ink composition including an aqueous ink vehicle and a pigment dispersed therein; and
a phosphonium-containing polyurethane composition comprising an aqueous liquid vehicle including water, organic co-solvent, and surfactant, wherein the phosphonium-containing polyurethane composition further includes polyurethane particles, the polyurethane particles including a polyurethane polymer with a polyurethane backbone, the polyurethane polymer having pendant side chain groups along the polyurethane backbone as well as end cap groups terminating the polyurethane polymer, wherein the pendant side chain groups and the end cap groups collectively include aliphatic phosphonium salts and polyalkylene oxides.

8. The fluid set of claim 7, wherein the ink composition includes polymer binder particles.

9. The fluid set of claim 7, wherein the pendant side chain groups of the polyurethane particles include the aliphatic phosphonium salts, and the end cap groups include the polyalkylene oxides.

10. The fluid set of claim 7, wherein the pendant side chain groups of the polyurethane particles include the polyalkylene oxides, and the end cap groups include the aliphatic phosphonium salts.

11. The fluid set of claim 7, wherein the aliphatic phosphonium salts of the polyurethane particles include a trialkylphosphonium salt with the three alkyl groups independently including a C1 to C5 straight or branched carbon chain.

12. The fluid set of claim 7, wherein the polyalkylene oxides of the polyurethane particles include polyethylene oxides, polypropylene oxides, or a combination thereof, and wherein the polyalkylene oxides independently have a number average molecular weight from 500 Mn to 15,000 Mn.

13. The fluid set of claim 7, wherein the polyurethane backbone of the polyurethane particles includes urethane linkage groups formed by reacting polymeric polyols with 2,2,4-trimethylhexane-1,6-diisocyanate; 2,4,4-trimethylhexane-1,6-diisocyanate; hexamethylene diisocyanate; methylene diphenyl diisocyanate; isophorone diisocyanate; 1-Isocyanato-4-[(4-isocyanatocyclohexyl)methyl]cyclohexane; or a combination thereof.

14. A method of printing, comprising:
jetting a phosphonium-containing polyurethane composition onto a media substrate, the phosphonium-containing polyurethane composition comprising an aqueous liquid vehicle including water, organic co-solvent, and surfactant, wherein the phosphonium-containing polyurethane composition further includes polyurethane particles, the polyurethane particles including a polyurethane polymer with a polyurethane backbone, the polyurethane polymer having pendant side chain groups along the polyurethane backbone as well as end cap groups terminating the polyurethane polymer, wherein the pendant side chain groups and the end cap groups collectively include aliphatic phosphonium salts and polyalkylene oxides; and
jetting an ink composition onto the media substrate, the ink composition including a pigment dispersed in an aqueous ink vehicle,
wherein after jetting the phosphonium-containing polyurethane composition and the ink composition, the phosphonium-containing polyurethane composition and the ink composition are in contact on the media substrate.

15. The method of clam 14, wherein the media substrate is fabric.
